(19) United States
(12) Patent Application Publication
(10) Pub. No.: US 2003/0208399 A1
(43) Pub. Date: Nov. 6, 2003

(54) Personalized product recommendation

(76) Inventors: Jayanta Basak, New Delhi (IN); Raghuram Krishnapuram, New Delhi (IN)

Correspondence Address: T. Rao Coca, IBM Corporation, Intellectual Property Law, 650 Harry Road, Dept. C4TA/J2B, San Jose, CA, 95120-6099, US

(21) Appl. No.: 10/138,857

(22) Filed: May 3, 2002

(51) Int. Cl. G06F 17/60

(52) U.S. Cl. 705/14

(57) ABSTRACT

A method, system and computer program product for generating a personalized list of items for a user are disclosed. The method includes the steps of storing inter-item relationships, adaptively identifying and storing users' interests based on behavioral patterns of users and generating a personalized list of items for a user, based on the user's stored interests and the inter-item relationships. The method optionally includes the additional steps of identifying and storing attributes of items and defining the inter-item relationships on the basis of the degree of similarity between item attributes. A user's interests can also be categorized on the basis of item attributes. The system and computer program product disclosed are for performing the steps of the foregoing method.

### FIELD OF THE INVENTION

The present invention relates to personalization, particularly in the context of item or product recommendation in business-to-consumer (B2C) e-commerce.

### BACKGROUND

Recommending products or displaying a suitable product catalog at e-commerce sites is very important in the perspective of satisfying customers' choices. The importance is more so when a merchant wishes to promote certain new products and make relevant information available to the customers. In the B2C (business-to-consumer) e-commerce paradigm, such product catalogs should ideally satisfy each customer's individual needs. In other words, not all product categories will necessarily be shown to a particular user, or even if they are displayed to a particular user, the manner of displaying the products may vary from user to user.

In general, the product categories are arranged in the form of a product tree or a directed graph (e.g. IBM WebSphere Commerce Suite™, version 5.1). At the root, there is a single node describing all the products. Then the categories and subcategories are arranged in different levels of the tree. It should be mentioned that the hierarchy of the product models is not exactly a tree, but rather a directed graph. A subcategory may belong to more than one parent category, because the subcategory may satisfy the properties of multiple parent categories to some extent. This is because real products often overlap classification subcategories.

In existing commerce servers, products hierarchies are, in general, static in nature (i.e. the catalogs do not change depending on customers' interests). In a personalized product recommendation model, it is desirable that product hierarchies depend on users' interests. The interests of each individual user may be captured in a customer profile and, based on the profile attributes, the product hierarchies can be built. However, a major problem is the bottleneck created by millions of users who may have widely varying interest patterns, thus, in order to have a completely personalized product model, millions of interest patterns will need to be recognized and satisfied. In other words, by simply building product hierarchies for each individual customer, an enormous number of such models needs to be stored, thus requiring an enormous amount of storage space and processing time.

Attempts have been made to base product catalogs on collaborative filtering, by identifying a group of users having a set of common patterns of interest/s. In this approach, the required number of product models will likely be reduced by a large factor, although a large number of different such hierarchies will still have to be maintained. Also, in the case of collaborative filtering, minor changes in interest patterns of individual users within the same group will likely not be captured in the recommendation model.

The problem identified is also relevant to targeting advertisements. In this domain, the problem may be considered as determining the list of advertisements that match a user's interests. Attempts have been made to target products and advertisements intelligently by considering customer segments having common factors of interests (collaborative filtering) and subsequent analysis of click rates. Click rates refer to user keypress rates relating to a particular user selection and are indicative of the popularity and/or amount of use of that particular selection. One example is the selection (i.e. “clicking on”) an icon (for example, of a product or category) on an Internet website.

In view of the foregoing, a need exists for personalized product recommendation that substantially overcomes or at least ameliorates disadvantages associated with existing arrangements.

### SUMMARY

According to aspects of the present invention, a method, system and computer program product for generating a personalized list of items for a user are disclosed. The method includes the steps of storing inter-item relationships, adaptively identifying and storing users' interests based on behavioral patterns of users and generating a personalized list of items for a user, based on the user's stored interests and the inter-item relationships.

The method optionally includes the additional steps of identifying and storing attributes of items and defining the inter-item relationships on the basis of the degree of similarity between item attributes. A user's interests can also be categorized on the basis of item attributes. Preferably, users' interests are stored in a a tree-like structure or a digraph-like structure.

The step of defining inter-item relationships can also be based on a requirement to promote certain items and/or on historical interest in items by users.

Other aspects of the present invention provide a system and computer program product for performing the steps of the foregoing method aspect.

In a preferred embodiment, a scheme for dynamic generation of a completely personalized product hierarchy is disclosed. The dynamically generated product hierarchy is an ordered subset of products that are of interest to a user. A key concept called product graph is introduced which essentially stores the product-id's as the vertices and the similarity relations between the products in the edges. A given user's interests are stored in an individual interest hierarchy which in turn stores one exemplar product-ID in each leaf node.

The exemplar represents the interest corresponding to the leaf node. Whenever a user traverses his interest hierarchy and reaches one of the leaf nodes, all the products that are similar to the exemplar product that is stored in the leaf node are retrieved from the product graph. Retrieving the products similar to the stored exemplar is in a sense analogous to the concept of case-based reasoning in the manifold of product attributes. A matching function between the product attributes and user's interests is thus mathematically formulated. If the matching score is greater than a certain threshold then the corresponding product is considered to be similar and is retrieved.

The product graph concept enables dynamic generation of a completely personalized product recommendation model for a user (consumer or customer) depending on the user's interests.

The dynamic product hierarchy model is particularly applicable to a personalized commerce server, which generates a personalized product list on-line, based on a user's interests. A user's interests are represented by a set of attributes that are captured in the user's User Interest Hierarchy (UIH). Thus, a customer's UIH is arranged based on certain attributes which are adaptively updated depending on the customer's behavior and/or feedback from the customer. This can be performed by learning the customer's interests adaptively (e.g. by a supervised or reinforcement learning process) and continuously updating the UIH.

The products and their attributes are stored in a table (PT) and the relationships between the products are stored in a Product Graph (PG). The PT and the PG are static parts of the personalized product recommendation model and are common for all users. In contrast, the UIH is a dynamic data structure maintained for each user. Whenever a user's (customer's) presence is detected by a personalized commerce server, information relating to the products that are likely to satisfy the user's interests, is retrieved from the PG and the PT based on the user's UIH.

In other embodiments, the present invention can be applied to personalized media mining, content-based image retrieval and similarity search, distance education and digital library search, targeted advertising and targeting potential customers.

### BRIEF DESCRIPTION OF THE DRAWINGS

Features and preferred embodiments of the present invention are described hereinafter with reference to the accompanying drawings in which:

FIG. 1 is a block diagram of a system for dynamically generating a personalized product hierarchy or list according to an embodiment of the present invention;

FIG. 2 shows an exemplary User Interest Hierarchy (UIH);

FIG. 3 shows a different exemplary User Interest Hierarchy (UIH);

FIG. 4 is a flow diagram of a method for dynamically generating a product hierarchy or list according to an embodiment of the present invention; and

FIG. 5 is a block diagram of an exemplary computer system wherewith embodiments of the present invention can be practiced.

### DETAILED DESCRIPTION

The principles of the preferred method, apparatus and computer program product described herein have general applicability to the generation of personalized hierarchies or lists. For ease of explanation, the steps of the preferred method, apparatus and computer program product are described with particular reference to an online site of a merchant. However, it is not intended that the present invention be limited to the described method, apparatus and computer program product as the invention has general application to the generation of personalised hierarchies or lists.

In the case of content-based image retrieval, the method, apparatus and computer program product described hereinafter can be used to generate personalized hierarchies or lists of images of interest to the user with particular reference to an online image database.

In the case of a digital library, the method, apparatus and computer program product described hereinafter can be used to generate personalized hierarchies or lists of educational material of interest to the user with particular reference to an online repository of educational material (digital library).

The method, apparatus and computer program product described hereinafter can also be used to to generate personalized hierarchies or lists of Web pages of interest to the user with particular reference to the World Wide Web or an institution's intranet, or a part thereof.

It should be noted that references herein to product/s and/or item/s encompass good/s and/or service/s within the intended scope.

An Exemplary System for Dynamically Generating a Personalized Product Hierarchy

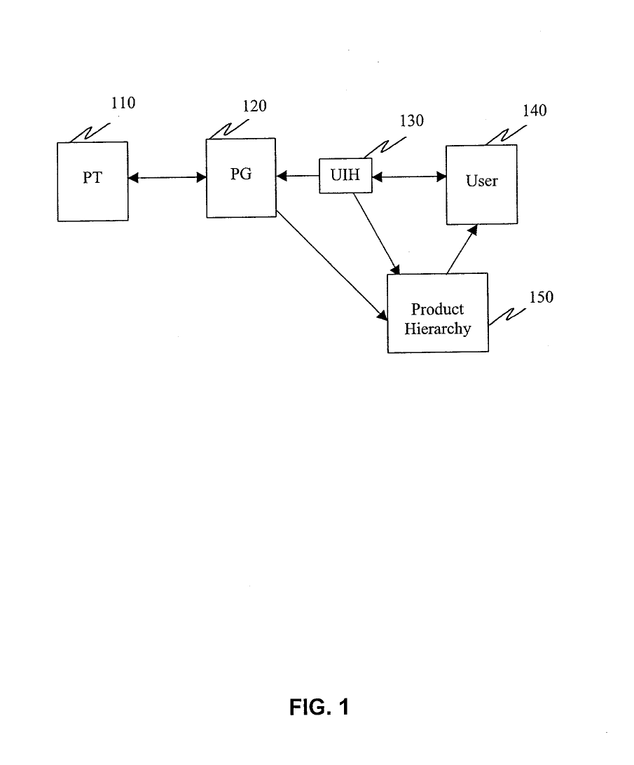

FIG. 1 is a block diagram of a system for dynamically generating a personalized product hierarchy or list. The product descriptions along with the product-id's are stored in a Product Table (PT) 110, which is essentially a static structure. However, a merchant can add items to or delete items from the PT 110, typically by means of a software program incorporating a Graphical User Interface (GUI).

The product-id's and a measure of the similarities between the attributes of different products are stored in the a Product Graph (PG) 120. Whenever a product is added to or deleted from the PT 110, the PG 120 is automatically updated accordingly. A software tool incorporating a GUI can also be provided that enables similarities between products to be quantified and/or defined by a merchant.

The interests of users (customers) 140 are stored in the form of a tree or digraph in a User Interest Hierarchy (UIH) 130. A UIH 130 is generated for each user and is dynamically updated based on a user's profile and behavior. Neither a user nor a merchant has any direct control over a UIH 130.

A personalized Product Hierarchy or List 150 is dynamically generated for use or viewing by a particular user 140, based on information contained in the PG 120 and the UIH 130 of the particular user 140.

The Product Table (PT)

Each product in the personalized product recommendation model has a set of attributes along with a product-id that are stored in a database table, known as a Product Table (PT) 110. The attributes are typically stored in the columns of the PT 110 with each row of the PT 110 representing a particular product. It is desirable that the product attributes exhaustively address all users' (customers') interests (the customers' interest patterns are described later). In other words, each attribute of each product has a correspondence (relation) with a preference or interest of some user. For example, if ‘color’ is a product attribute, then it is assumed that a user's preference for a product can change depending on the value of this attribute. In other words, in modeling a user (as described later), color is considered a factor in the user's preferences or interests. The list of product attributes is a superset of the factors that appear in the preference or interest lists of all users.

The product attribute set typically includes, but is not limited to, attributes such as category name, sub-category name, shape, size, color, price, and brand. A product may be associated with more than one category (the same concept is used in the static product hierarchy). For example, a book may be associated with categories such as ‘literature’ and ‘gift-items’. In such cases, a list of categories may be maintained against each product-id. The product attribute set is a static data structure and whenever a new product is introduced, appropriate attribute fields are set accordingly (typically by the merchant).

For the sake of representation, a product model Fⱼ^{p} can be defined for a set of m attributes:

Fⱼ^{p}={fⱼ₁^{p}, fⱼ₂^{p}, . . . fⱼₘ^{p}}

where:

fₘ^{P} represents the m^{th} attribute or feature f of a product j

Each attribute (or feature) may comprise a categorical, numeric or binary value, depending on the type of the attribute. For example, the first attribute may represent a category (e.g., food, automobile, garments, books and sports-item) and there may be C categories available from a particular merchant. Then the first attribute is a categorical variable taking values in the set {1, . . . C}. Now, assuming the second field represents subcategories such as ‘literature’, ‘science fiction’, ‘hot drink’, ‘golf item’ or ‘winter garment’, there can be Cₛ such subcategories for all categories that may be represented by categorical values in {1, . . . Cₛ}. A number of qualifiers may be maintained for a product (in the PT 110) such as ‘gift item’, ‘party special’, ‘frequently sold’ and so on, which are useful for determining similarities between products (as discussed hereinafter). Attributes may represent physical properties of a product such as color, shape, and size. The PT 110 can contain other attributes such as price, season (when the product is brought), brand and so on. It is desirable that attributes characterize a product well and differentiate the product from other products. The attributes are generally specified by a merchant at the time of introducing the product.

Apart from the PT 110 for storing the product-ids along with the product attributes, another static part of the personalized product recommendation model is the Product Graph (PG) 120.

The Product Graph (PG) The Product Graph (PG) 120 can be defined as:

M={P, R}

where:

P={pᵢ} is the set of product-ids stored as vertices of the PG 120,

R={rᵢⱼ} is the set of relations between the products Pᵢ and Pⱼ, stored as edges of the PG 120.

Here, the ‘relation’ rᵢⱼ represents a set of similarity indices between the attributes of products Pᵢ and Pⱼ. A similarity index indicates the degree of similarity between the attributes of two products.

The edge rᵢⱼ connecting the products Pᵢ and Pⱼ (stored as product-ids i and j in the PG 120) has a set of degrees of similarity:

rᵢⱼ={w₁^{ij}, w₂^{ij}, . . . wₘ^{ij}}

where:

each wₖ^{ij} denotes a numeric value in the range [0,1], indicating the degree of similarity between the attributes fᵢₖ^{p} and fⱼₖ^{p} of the two products Pᵢ and Pⱼ, respectively.

As an example, consider the color attribute Wₖ^{ij} that indicates how similar the products Pᵢ and Pⱼ are in color. If products Pᵢ and Pⱼ are identical in color then wₖ^{ij}=1. If the products Pᵢ and Pⱼ are of completely different colors, wₖ^{ij}=0. The degree of similarity or similarity index wₖ^{ij} will thus take a value in the interval [0,1] if the colors of two products are not exactly the same but have some similarity (e.g. red and pink). Similarity indices for other attributes such as shape, size and price can be analogously defined.

The exact manner in which the similarity indices (or the degrees of similarity) are defined depends on how the product attributes are modelled. For instance, the similarity index may be defined based on a parameterized function. In this case, the problem reduces to estimation of the parameters of such a function. The function may be manually defined or the parameters may be learned from different similar and dissimilar examples of products (i.e. in a supervised mode). Here it should be mentioned that the product attributes may take different categorical or non-numeric values besides binary and numeric values, whereas the similarity indices are always numeric in nature ([0,1] or binary {0,1}, which is a restricted case of [0,1]).

Similarity indices for categorical attributes may have a different connotation in comparison to similarity indices for other physical attributes such as color, shape, price, and size. In the latter case, once the attributes are mathematically modelled, the corresponding similarity indices can also be quantified. However, it may be difficult to mathematically define similarity indices for categorical attributes. For example, a fiction-category book and a CD player may both be considered as gift items and both products will thus have the product attribute ‘gift item’. The link connecting the two products should have a value indicating how far these two products are comparable as far as gift items are concerned. Such comparisons may not be easily definable by simple mathematical modeling and the similarity indices could rather be explicitly defined by the merchant or adaptively learned from the behavior (or feedback) of customers in general (as gleaned from customer profiles or click-stream analysis). For example, consideration of associations between products may provide some insight into the similarity indices of the categorical attributes. If the purchase patterns of all customers indicate that two particular items have a strong association (e.g. beer is often bought with chips), then the relevant similarity index can be set at a high level. A merchant can also create artificial attributes to incorporate associations between products for purposes of product promotion or product bundling as part of a sales strategy.

The User Interest Hierarchy (UIH)

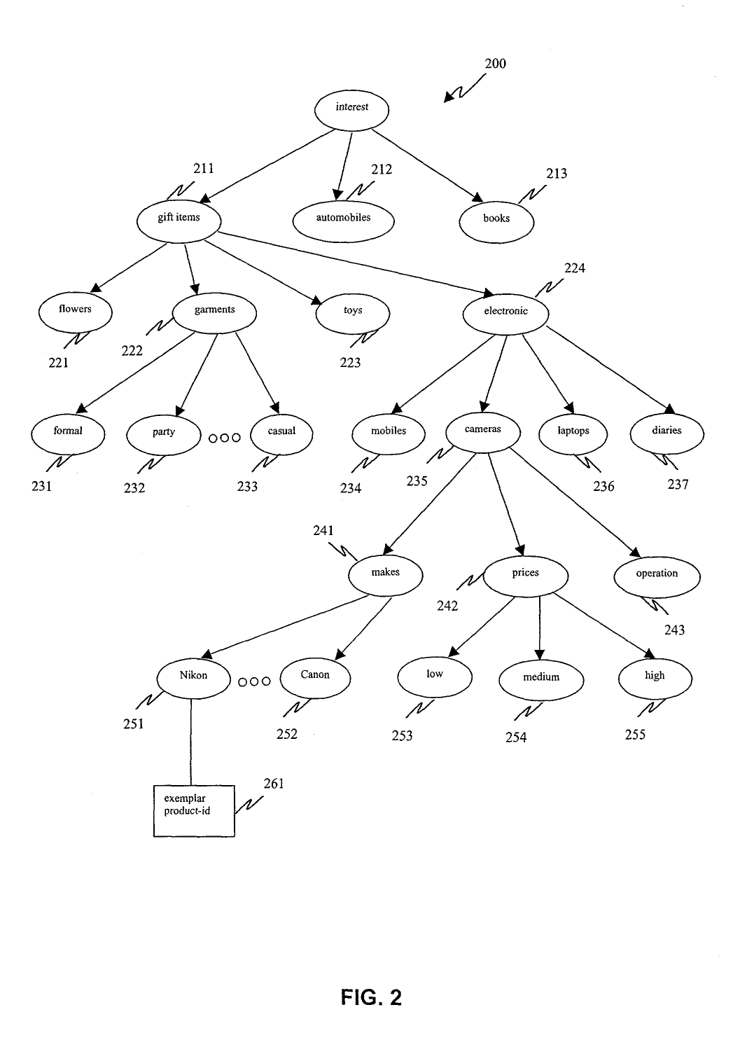

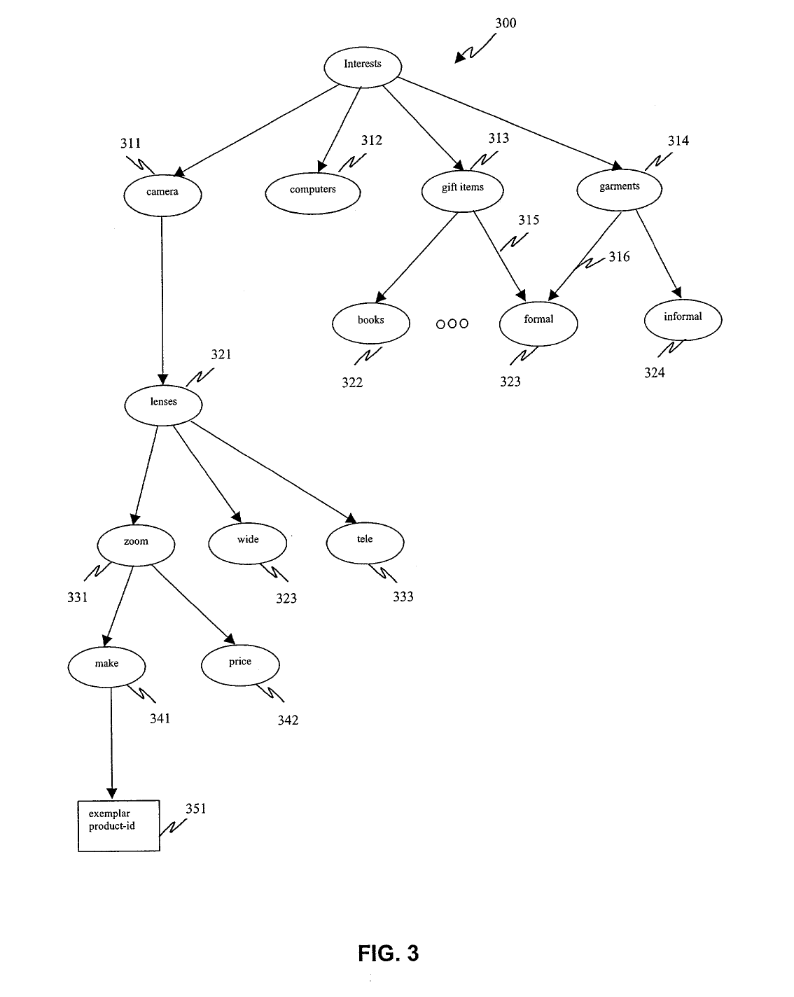

The dynamic product hierarchy to be shown to a user is generated from the particular User's (customer's) Interest Hierarchy (UIH) 130. Instead of a flat table, each individual customer's interests are stored in the form of a tree or a directed graph as shown in FIGS. 2 and 3. The UIH 130 of each individual customer is different to the product hierarchy in that all the products-ids are stored in a product hierarchy, whereas the interest hierarchy of a user is simply a representation of the user's interest patterns and is not used to store product id's. Thus, the UIH 130 of a user i can be represented as a set [μⁱⱼₗ], where l is the level in the interest hierarchy and j is the index for a node at level l.

For the sake of normalization, it may be considered that at each level, for all i and l:

Σⱼμⁱⱼₗ=1

The nodes of a UIH 130 represent particular types of interests which are either the same as, or correspond to, product attributes. For example, the attributes ‘gift_item’, ‘book’, and ‘garments’ may belong to a UIH 130 and also represent categorical attributes of products. Whenever a UIH 130 is traversed, a list of product attributes is specified depending on the order of traversal. Each leaf node of a UIH 130 stores an exemplar product-id and the product corresponding to the product-id is representative of an interest corresponding to the leaf node.

Whenever a user (customer) 140 logs onto or accesses an e-commerce site, a dynamic product hierarchy or list is generated based on the user's interest hierarchy (UIH) 130. If the user 140 clicks on a node in the UIH 130 to view all the products available under that node, the system traverses the UIH 130 from that node to the leaf nodes. After traversing the UIH 130 (a tree or directed graph) the system reaches the leaf nodes and records the nodes corresponding to exemplar product-ids (stored at the leaf nodes) in the PG 120 as well as a list of attributes defined by the traversal of the user's UIH 130 from the root node to the node where the user 140 clicked to view the products. This information is used to retrieve similar products from the PG 120. The subset of product items connected in the PG 120 that are similar to the exemplar product according to the list of attributes are then retrieved and displayed to the user 140.

The UIH 130 need not always be stored as a tree but may also be stored as a directed graph (as typically used in the static product hierarchy model employed in conventional commerce servers). More importantly, a product may belong to more than one category, but the importance of the attributes depend on the path followed by the user 140 during traversal of the user's interest tree (or directed graph). Thus, it is not necessarily true that the products retrieved will be the same as those products retrieved when a different path is traversed to reach the same leaf node by a user 140.

The interest hierarchy of each individual user requires much less storage space when compared to the static product hierarchy. The product hierarchy consists of all the products, many of which a user 140 may not be interested in. Moreover, each leaf node in the UIH 130 contains only one exemplar product-id. Storing the exemplar product-ids in the UIH 130 is analogous to the concept of case-based reasoning. In case-based reasoning, certain cases or exemplar patterns are stored under a supervised mode and, whenever a new pattern appears, a distance (not necessarily a distance in the Euclidian sense) is computed from the stored exemplars and subsequently labeled according to the closest exemplar. In case-based reasoning, every time a new pattern appears, the distance is explicitly computed. In the present model of a dynamic hierarchy, the PG 120 already stores the distances of different products (in the sense of similarity) from the exemplar products stored at leaf nodes of the UIH 130. Therefore, it is unnecessary to compute these distances during a session (when on-line).

### EXAMPLES

FIG. 2 shows a UIH 200 of a first user interested in ‘gift items’ 211, ‘automobiles’ 212 and ‘books’ 213. Under the category ‘gift items’ 211, the user is interested in ‘flowers’ 221, ‘toys’ 223, ‘garments’ 220, and ‘electronics’ 224. Within the category ‘garments’ 222, the user is interested in ‘formal’ garments 231, ‘party’ garments 232 and ‘casual’ garments 233. Within the category ‘electronics’ 224, the user is interested in ‘mobiles’ 234, ‘laptops’ 236, ‘cameras’ 235, and ‘diaries’ 237. Within the category ‘cameras’ 235, the user is interested in ‘makes’ 241, ‘prices’ 242 and ‘operation’ 243 of cameras. Within the category ‘makes’ 241 of cameras 235, the user is interested in ‘Nikon™’ 251 and ‘Canon™’ 252. An exemplar product-id 261, stored in a lead node, may thus represent a particular model of Nikon camera.

FIG. 3 shows a UIH 300 of a second user, whose top-level interest categories are ‘cameras’ 311, ‘computers’ 213, ‘gift items’ 313, and ‘garments’ 314. Within the category ‘cameras’ 311, the user is interested in different types of lenses (‘zoom’ 331, ‘wide angle’ 323, and ‘tele’ 333). Within the category ‘zoom’ 331, the user is interested in the ‘make’ 341 and ‘price’ 342 of the lens. An exemplar product-id 351, stored in a leaf node, may thus represent a particular make of lens.

For the second user, the category ‘formal’ comes under the category ‘gift items’ as well as under the category ‘garments’. Therefore, the user may reach the ‘formal garment’ node by following either of paths 315 or 316.

However, the items that are considered similar and are thus retrieved from the PG 120 depend on the actual path that the user followed to reach the node. Referring to FIG. 2, if the user reaches a Nikon™ camera (assuming that the product-id 261 of a particular Nikon™ camera is stored in the leaf node as an exemplar), then the recorded list of attributes are {gift item, electronic, product type, product brand}.

The nodes of a UIH 130 further store certain weights (με[0,1]), specifying the degree of the user's interest in the category represented by each node. For example, the first attribute ‘gift item’ has the value of, say, 0.8. As previously described, the weights may be normalized across a particular level in the hierarchy. However, normalization may not always be necessary. Under ‘gift items’, ‘flowers’ may have a weight of 0.6, ‘garments’ a weight of 0.3, ‘toys’ a weight of 0.9 and ‘electronics’ a weight of 0.7. The weights of the nodes are used when computing the similarity between the exemplar and other products in the PG 120. For example, in the case of ‘garments’, the weight is only 0.3 (under the category of ‘gift items’). Therefore, while retrieving similar items from the PG 120, only those garments which are very similar to the exemplar according to the gift item criterion (categorical attribute) can be retrieved, rather than all sorts of garments. The method of determining the set of similar items from the PG 120 is described hereinafter.

Method for Dynamically Generating a Product Hierarchy from a Product Graph

In order to dynamically generate a product hierarchy 150 from a UIH 130, the UIH 130 is first traversed and then the PG 120 is interrogated to retrieve a set of products similar to an exemplar product whose product-id is stored at a leaf node of the UIH 130.

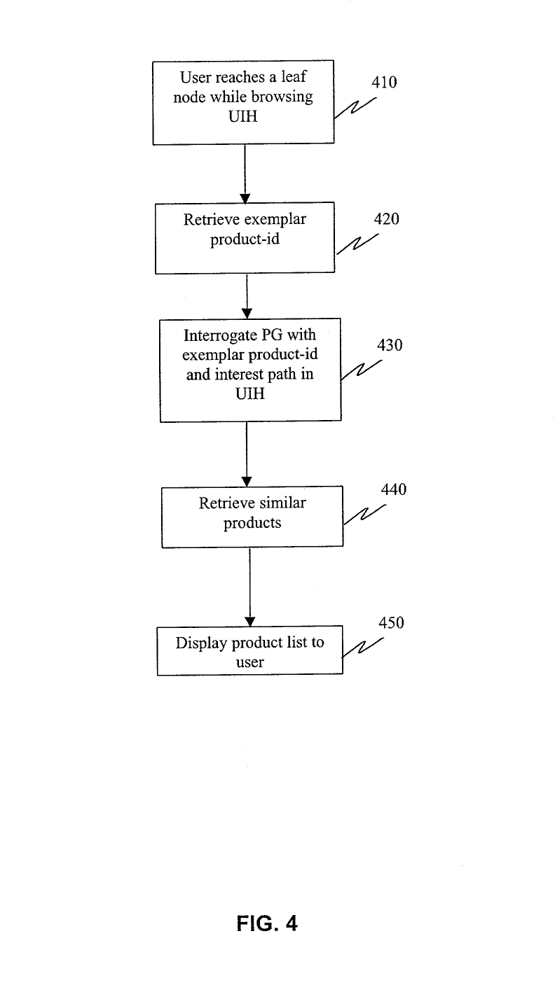

FIG. 4 is a flow diagram of a method for dynamically generating a product hierarchy or list.

At step 410, a user 140 reaches a leaf node of the UIH 130 while browsing. The exemplar product-id is retrieved from the leaf node of the UIH 130, at step 420.

At step 430, the PG 120 is interrogated, based on the exemplar product-id retrieved at step 420 and the interest path traversed by the user 140 in the UIH 130. Then, at step 440, other products similar to the exemplar product are retrieved from the PG 120.

At step 450, the personalized hierarchy or list of products 150 is displayed to the user 140.

The function Traverse(i), described hereinafter, returns a list of all the products of a user's interest under node i in the user's interest hierarchy. For example, if a user wishes to view all products under the root node of the user's interest hierarchy, then the function Traverse(root) will return a list of those products. The product list may be retrieved upon a user's request (i.e. whenever the user clicks interactively at any level of the hierarchy) and subsequently displayed to the user.

TABLE 1

Begin
Property(root) = null;
Traverse(root)
End
Procedure Traverse(i)
Begin

If level(i) != LEAF then
Begin

Sort(i);
For each k in Sort(i),
Begin

Property(k)= Append(Property(i), attribute(k));
Traverse(k);

End

End
Else

p = Get_product(i);

For all j in Rₚ (the set of edges connected to product p

in the product graph)

Begin

If rₚⱼ != null then

Begin

If Match(wₚⱼ (attribute), Property(i)) = HIGH

then

Begin

Set(i) = Set(i)^{∪{j}}

End

End

End

Return( );

End

(END TABLE 1)

Table 1 contains a pseudocode for a function Traverse( ), which calls various other functions or procedures:

Sort (i): returns a set of sorted interest categories under i, sorted according to the weights of the interest categories.

Property (k): returns a list of attributes that are associated with the node k of a user interest hierarchy. The list is obtained recursively by the traversal of the hierarchy.

Append (L1, L2): appends a list L2 with a list L1 and returns the concatenated list.

Get_product (i): returns the exemplar product-id stored at the leaf node of a user interest hierarchy.

Match(.): returns a value if the attributes specified by the list Property(i) take a high value in the corresponding link. As described previously, each link stores a similarity measure in each attribute field and therefore has a list of all attributes (some of them may be null). Only those attributes specified by the set Property (i) are checked and if all of those checked are of high value, a high value is returned.

Matching Attributes

The function Match(.) retrieves products which are similar to the exemplar product, from the product graph. Different heuristic similarity measures can be adopted for this task to satisfy the user's interests as well as the nature of the product attributes. For example, if a user is very interested in a particular subcategory then the user may like to view a wide variety of products available in that subcategory. On the other hand, if the user is only moderately interested in the particular subcategory then the user may not wish to see a wide variety, and the products retrieved should be substantially similar to the exemplar. At the extremes, it may be that a user is either interested or not interested (i.e. μ=1 or μ32 0, respectively, for all nodes in the interest hierarchy of a user). The nodes having a weight of 0 can be purged from the tree.

Let the exemplar product be Pᵢ and consider whether a product Pⱼ should be retrieved or not. Let the branch of the interest hierarchy be represented as {μₖ₁, μₖ₂, . . . μₖₗ}, such that k₁ is the user's interest category just under the root of the user's interest hierarchy, k₂ is the next level subcategory in the path of the hierarchy traversed by the user and so on, and kₗ is the subcategory at the leaf node storing the exemplar product-id. As previously discussed herein, k₁, k₂, . . . kₗ correspond to particular product attributes.

A binary decision may be made as to whether the product Pⱼ will be retrieved or not, based on the value of the expression:

$${\prod }_{s = 1}^{n} {w}_{{k}_{s}}^{i j}$$

If the value of the foregoing expression is 1 then the product Pⱼ will be retrieved, otherwise not. Here, it is assumed that the similarity index (as stored in PG 120) is also a binary value for all attribute fields.

Another way of representing the same decision is that the product Pⱼ will be retrieved if the value of the expression:

$${\sum }_{s = 1}^{l} {w}_{{k}_{s}}^{i j} \geq θ$$

If the value of the expression is less than θ then the product Pⱼ will not be retrieved.

Instead of binary similarity indices, if w takes a value in the range [0,1] for all attributes, the decision to retrieve a product Pⱼ may be made if:

$$\frac{{\sum }_{s = 1}^{l} {w}_{{k}_{s}}^{i j}}{l} \geq θ$$

where θ is a threshold value in the range [0,1]. If θ is very high (approaching a value of 1) then very few similar products, or none at all, will be retrieved. On the other hand, if θ is very low (approaching a value of 0) then most of the products will be retrieved as similar products.

Where the user's interests are not represented in a binary fashion (i.e. μ takes a value in the range [0,1]), the path followed by the user (customer) and defined as {μₖ₁, μₖ₂, . . . μₖₗ} represents a certain interest pattern where each level k is a predecessor of level λ+1 in the path of the interest hierarchy. Therefore, the degree of interest at a level λ+1 (i.e. μ^{kλ-1}) must be less than or equal to the degree of interest at a level λ. The structure of a UIH 130 is not fixed and depends on a particular user's behavior or interests. Certain learning algorithms including reinforcement learning and clustering may be employed for generating the UIH 130. Therefore, the relative superiority of an attribute (or interest category) in the hierarchy depends on the structure of the UIH 130 generated for a particular user.

As an example, assume that a user is interested in the category ‘gift item’. Under the category ‘gift item’, is the subcategory ‘book’. The interest weight for the subcategory ‘book’ indicates the weight for that subcategory as compared to other subcategories under the category ‘gift item’. Therefore, even if the weight for the subcategory ‘book’ is higher than the weight for the category ‘gift item’, in the interest hierarchy, this weight does not reflect the overall weight for the subcategory ‘book’. In order to compute the actual overall weight for the subcategory ‘book’, the weight for the category ‘gift item’ must also be taken into account. Thus, there is certain inheritance of the importance or weights of the interest categories for retrieving similar products from the PG 120. If the weight of interest for the subcategory ‘book’ is 1 then the actual overall weight of interest for the subcategory ‘book’ might be 0.3 (which is the weight for the category ‘gift item’), for retrieving similar books. The inheritance property can be accommodated by having two different similarity measures, which are described below. However, various other measures may be used to incorporate the inheritance property and the similarity indices.

If the importance or the weights of the interests (μ) are normalized across a level under any category or subcategory, then the degree of similarity vᵢⱼ between the product Pⱼ and the product Pᵢ (the stored exemplar in a leaf node) may be defined as:

$$\begin{matrix}\begin{matrix}\begin{matrix}{v}_{i j} = {w}_{{k}_{l}}^{i j} \cdot {μ}_{{k}_{1}} + {w}_{{k}_{2}}^{i j} \cdot min \{ {μ}_{{k}_{1}} , {μ}_{{k}_{2}} , \} + {w}_{{k}_{3}}^{i j} \cdot \\ min \{ {μ}_{{k}_{1}} , {μ}_{{k}_{2}} , {μ}_{{k}_{1}} \} + … + {w}_{{k}_{l}}^{i j} \cdot min \{ {μ}_{{k}_{1}} , {μ}_{{k}_{2}} , … , {μ}_{{k}_{l}} \} \end{matrix} \\ i . e .\end{matrix} \\ {v}_{i j} = {\sum }_{s = 1}^{l} {w}_{{k}_{s}}^{i j} \cdot min \{ {μ}_{{k}_{1}} , {μ}_{{k}_{2}} , … , {μ}_{{k}_{s}} \}\end{matrix}$$

and the product Pⱼ will be retrieved if:

$$\frac{{v}_{i j}}{l} \geq θ$$

For the case of unnormalized weights of interests, the matching function may be defined as:

$${v}_{i j} = {\sum }_{s = 1}^{l} {w}_{{k}_{s}}^{i j} \cdot {\prod }_{t = 1}^{s} {μ}_{{k}_{t}}$$

and, analogously, the product j will be retrieved if:

$$\frac{{v}_{i j}}{l} \geq θ$$

Thus, the retrieval of products depends on how the interest tree has been structured (normalized or unnormalized weights for interests) and how the threshold θ is set. The threshold, itself, may also be user dependent. For example, a particular user may like to browse through many products, while another user may be impatient. In the first case, the threshold should be set at a lower value, while in the latter case, a higher value of threshold should be set.

Storage Complexity

In a static product hierarchy, all the available products are stored along with their relevant subcategories. Thus, if there are n products available then the maximum number of leaf nodes will be n. Assuming a constant branching factor b in the tree (which is a very idealistic assumption), the amount of storage required is:

$$\frac{b \cdot n - 1}{O ( b - 1 )}$$

For large b, and a fixed attribute set size, the amount of storage required reduces to:

O(n)

On the other hand, in the PG 120, it may be presumed that every product-id is connected to every other by some edge. Therefore, again for a fixed attribute set, the storage space requirement increases to:

O(n²)

It may be assumed here that each UIH 130 is much smaller than the static product hierarchy typically stored in conventional commerce servers.

Assuming that there are m users (customers) and each user is interested in N subcategories (at the level of leaf nodes), on average, then the approximate storage space required for all users and the static product graph (also assuming a fixed size of attribute set and a large branching factor in the user interest hierarchy) is:

O(mN+n²)

If a static product hierarchy needed to be maintained for every individual user (customer), then the storage space required would be:

O(mn)

If it is assumed that N<<n<<m (i.e. that the total number of users (customers) is much greater than the total number of products), then O(mN+n²)<<O(mn). In other words, the storage requirement for such a dynamic product hierarchy is much less than that required for a static hierarchy assigned to each individual user. A significant advantage of dynamic hierarchy generation is that the generated hierarchy can be altered by simply varying certain thresholds. Moreover, a merchant can promote certain products by simply adding the products to the PG 120, which is essentially a static structure that users have no control over.

The similarity relations may be considered as commutative (i.e. the similarity of product A with product B may be considered the same as the similarity of product B with product A). In such cases, the PG 120 can be stored as an undirected graph, thus requiring half the storage space required by a directed graph.

In certain cases, it may occur that m<n (i.e. the assumption that n<<m may not be valid, for example, in the case of a book store or a grocery store, where the total number of products is greater than the total number of customers). In such cases, maintaining a completely connected PG 120 may be very expensive as far as storage complexity issues are concerned and several alternative structures could be maintained, as discussed hereinafter.

In the PG 120, each product is connected to every other product by a set of similarity indices with respect to the set of product attributes. The similarity indices enable comparative evaluations of the products. However, it may not be necessary, or even useful, to compare every product with every other product. Products in widely different categories may be linked by similarity indices representing certain physical attributes that may not be of any practical use to any user. For example, it may not be necessary for an automobile to be connected to a garment with respect to color or for a baseball bat to be connected to a sausage with respect to shape. Thus, a PG 120 may be split into several product subgraphs by considering only the relevant similarities and dissimilarities between the categorical attributes of the products. In other words, instead of maintaining a single completely connected PG 120, a set of product subgraphs (clusters) may be maintained. The product subgraphs may be disjoint or very sparsely connected to each other. Each subgraph, in turn, may further be split into several sparsely connected subgraphs with respect to the next level of categorical attributes. Thus, instead of requiring an O(n²) connectivity, a much lower order of connectivity may be necessary to maintain the set of sparsely connected subgraphs. Splitting of a PG 120 into constituent subgraphs or a subgraph into lower order subgraphs may be performed based on clustering or hierarchical clustering algorithms. The objective function for clustering should take into account the overall interests of all users to evaluate the similarities (distances) between the product attributes (e.g. one user may be interested to see the garments and automobiles of similar color at the same time, however the other users may not be). In such a case, these two categories may be maintained in different subgraphs based on the overall users' requirements or preferences. If a product graph is split into several disjoint or sparsely connected subgraphs, the algorithm for generating the dynamic product hierarchy remains substantially unaltered.

Targeted Advertising

Another use of personalization in the Business-to-Consumer (B2C) paradigm, is dynamic selection of customers (users) for targeting of certain products or advertisements to maximise click-through. In this case, a customer graph (CG) is maintained instead of a PG 120. In a CG, each customer is connected to every other customer based on some similarities in the customers' profiles. Thus, if a product is shown to one customer then, based on the similarity indices in the CG, the relative benefit of displaying the product to other customers (users) can be computed.

A CG has two main uses. Firstly, given a CG with similarity indices between customer profiles, it is straightforward for a merchant to identify a customer segment with similar interests to whom a particular product should be shown. Thus, a customer graph can be useful for targeting products and advertisements, and promoting and bundling products. A second use of a CG is in the personalized product recommendation model. Analogous to the PG and UIH-based recommendation algorithm, a few customer interest hierarchies (including the product-id's) need to be maintained as prototypes. Whenever a customer logs on, the similarity indices of the customer's profile with those of the prototype customers will be determined and, based on these similarity indices, a interest hierarchy for that individual customer can be generated.

Computer Hardware and Software

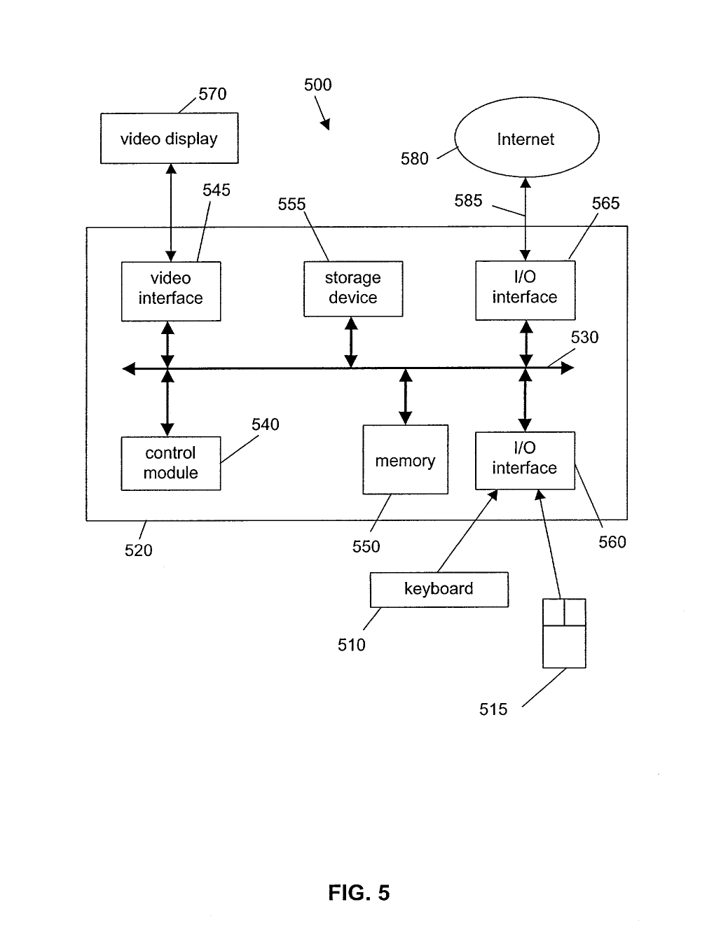

FIG. 5 is a schematic representation of a computer system 500 that can be used to perform steps in a process that implement the techniques described herein. The computer system 500 is provided for executing computer software that is programmed to assist in performing the described techniques. This computer software executes under a suitable operating system installed on the computer system 500.

The computer software involves a set of programmed logic instructions that are able to be interpreted by the computer system 500 for instructing the computer system 500 to perform predetermined functions specified by those instructions. The computer software can be an expression recorded in any language, code or notation, comprising a set of instructions intended to cause a compatible information processing system to perform particular functions, either directly or after conversion to another language, code or notation.

The computer software is programmed by a computer program comprising statements in an appropriate computer language. The computer program is processed using a compiler into computer software that has a binary format suitable for execution by the operating system. The computer software is programmed in a manner that involves various software components, or code means, that perform particular steps in the process of the described techniques.

The components of the computer system 500 include: a computer 520, input devices 510, 515 and video display 570. The computer 520 includes: control module or processor 540, memory module 550, input/output (I/O) interfaces 560 and 565, video interface 545, and storage device 555.

The control module or processor 540 is a central processing unit (CPU) that executes the operating system and the computer software executing under the operating system. The memory module 550 includes random access memory (RAM) and read-only memory (ROM), and is used under direction of the processor 540.

The video interface 545 is connected to video display 570 and provides video signals for display on the video display 570. User input to operate the computer 520 is provided from input devices 510 and 515 consisting of keyboard 510 and mouse 515. The storage device 555 can include a disk drive or any other suitable non-volatile storage medium.

Each of the components of the computer 520 is connected to a bus 530 that includes data, address, and control buses, to allow these components to communicate with each other via the bus 530.

The computer system 500 can be connected to one or more other similar computers via a input/output (I/O) interface 565 using a communication channel 585 to a network 580, represented as the Internet.

The computer software program may be provided as a computer program product, and recorded on a portable storage medium. In this case, the computer software program is accessed by the computer system 500 from the storage device 555. Alternatively, the computer software can be accessed directly from the network 580 by the computer 520. In either case, a user can interact with the computer system 500 using the keyboard 55 and mouse 515 to operate the programmed computer software executing on the computer 520.

The computer system 500 is described for illustrative purposes: other configurations or types of computer systems can be equally well used to implement the described techniques. The foregoing is only an example of a particular type of computer system suitable for implementing the described techniques.

Conclusion

A method, system and computer software program are described herein for dynamically generating personlized product hierarchies. However, various alterations and modifications can be made to the techniques and arrangements described herein, as would be apparent to one skilled in the relevant art.

We claim:

1. A method for generating a personalized item list for a user, said method including the steps of:
storing inter-item relationships;
adaptively identifying and storing users' interests based on behavioral patterns of said users; and
generating a personalized list of items for a user, based on said user's stored interests and said inter-item relationships.

2. The method of claim 1, including the further steps of:
identifying and storing attributes of a plurality of items; and
defining inter-item relationships based on the degree of similarity between attributes of said items.

3. The method of claim 2, including the further step of categorizing said user's interests based on said attributes of said items.

4. The method of claim 3, wherein said users' interests are stored in a structure selected from the group consisting of:
a tree-like structure; and
a digraph-like structure.

5. The method of claim 2, wherein said step of defining inter-item relationships is further based on a requirement to promote certain items.

6. The method of claim 2, wherein said step of defining inter-relationships is further based on historical interest in items by users.

7. A method according to claim 1 for personalized media mining, wherein said items comprise World Wide Web pages and said personalized list of items comprises a personalized list of World Wide Web pages.

8. A method according to claim 1 for content-based image retrieval and similarity search, wherein said items comprise images and said personalized list of items comprises a personalized list of images.

9. A method according to claim 1 for distance education and digital library search, wherein said items comprise educational material and said personalized list of items comprises a personalized list of educational material.

10. A method according to claim 1 for targeted advertising, wherein said inter-item relationships comprise item-advertisment relationships and said personalized list of items comprises a list of advertisments.

11. A method according to claim 1 for targeting potential customers, wherein said items comprise potential customers and said personalized list of items comprises a list of potential customers to be targeted.

12. A system for generating a personalized item list for a user, including:
means for storing inter-item relationships;
means for adaptively identifying and storing users' interests based on behavioral patterns of said users; and
means for generating a personalized list of items for a user, based on said user's stored interests and said inter-item relationships.

13. The system of claim 12, further including:
means for identifying and storing attributes of a plurality of items; and
means for defining inter-item relationships based on the degree of similarity between attributes of said items.

14. The system of claim 13, further including means for categorizing said user's interests based on said attributes of said items.

15. The system of claim 14, wherein said users' interests are stored in a structure selected from the group consisting of:
a tree-like structure; and
a digraph-like structure.

16. The system of claim 13, wherein definition of said inter-item relationships is further based on a requirement to promote certain items.

17. The system of claim 13, wherein definition of said inter-item relationships is further based on a history interest in items by users.

18. A system according to claim 12 for personalized media mining, wherein said items comprise World Wide Web pages and said personalized list of items comprises a personalized list of World Wide Web pages.

19. A system according to claim 12 for content-based image retrieval and similarity search, wherein said items comprise images and said personalized list of items comprises a personalized list of images.

20. A system according to claim 12 for distance education and digital library search, wherein said items comprise educational material and said personalized list of items comprises a personalized list of educational material.

21. A system according to claim 12 for targeted advertising, wherein said inter-item relationships comprise item-advertisment relationships and said personalized list of items comprises a list of advertisments.

22. A system according to claim 12 for targeting potential customers, wherein said items comprise potential customers and said personalized list of items comprises a list of potential customers to be targeted.

23. A computer program product comprising a computer readable medium having a computer program recorded therein for generating a personalized item list for a user, said computer program product including:
computer program code means for storing inter-item relationships;
computer program code means for adaptively identifying and storing users' interests based on behavioral patterns of said users; and
computer program code means for generating a personalized list of items for a user, based on said user's stored interests and said inter-item relationships.

24. The computer program product of claim 23, further including:
computer program code means for identifying and storing attributes of a plurality of items; and
computer program code means for defining inter-item relationships based on the degree of similarity between attributes of said items.

25. The computer program product of claim 24, further including computer program code means for categorizing said user's interests based on said attributes of said items.

26. The computer program product of claim 25, wherein said users' interests are stored in a structure selected from the group consisting of:
a tree-like structure; and
a digraph-like structure.

27. The computer program product of claim 24, wherein definition of said inter-item relationships is further based on a requirement to promote certain items.

28. The computer program product of claim 24, wherein definition of said inter-item relationships is further based on historical interest in items by users.

29. A computer program product according to claim 23 for personalized media mining, wherein said items comprise World Wide Web pages and said personalized list of items comprises a personalized list of World Wide Web pages.

30. A computer program product according to claim 23 for content-based image retrieval and similarity search, wherein said items comprise images and said personalized list of items comprises a personalized list of images.

31. A computer program product according to claim 23 for distance education and digital library search, wherein said items comprise educational material and said personalized list of items comprises a personalized list of educational material.

32. A computer program product according to claim 23 for targeted advertising, wherein said inter-item relationships comprise item-advertisment relationships and said personalized list of items comprises a list of advertisments.

33. A computer program product according to claim 23 for targeting potential customers, wherein said items comprise potential customers and said personalized list of items comprises a list of potential customers to be targeted.
